(19) United States
(12) Patent Application Publication
(10) Pub. No.: US 2006/0179468 A1
(43) Pub. Date: Aug. 10, 2006

(54) System and method of providing a television content guide

(75) Inventor: Larry B. Pearson, San Antonio, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P.

(21) Appl. No.: 11/052,006

(22) Filed: Feb. 4, 2005

(51) Int. Cl. G06F 13/00; G06F 3/00; H04N 7/173; H04N 5/445

(52) U.S. Cl. 725/110; 725/109; 725/39

(57) ABSTRACT

A method of providing a content guide includes receiving a request for a content guide. The request for the content guide is transmitted to a web server. Thereafter, the content guide is received from the web server. Further, the content guide is modified according to one or more parental controls after determining that the one or more parental controls are enabled. The method also includes retrieving the one or more parental controls from a database within a set top box server before modifying the content guide. The one or more parental controls can prevent one or more programs from being available at a television coupled to the set top box at least partially based on a rating associated with the one or more program. Further, the content guide is modified to delete information associated with the one or more programs not available at the television.

### FIELD OF THE DISCLOSURE

The present disclosure relates to set top boxes and content guides.

### BACKGROUND

Cable television providers, satellite television providers, and Internet protocol (IP) video providers typically can deliver a program guide or content guide via a set top box in addition to the actual content that is provided. Web based content guides, such as the content guide provided by Yahoo, are also available. Unfortunately, the content guides available at the set top box and the content guides available on the Internet are not integrated. The lack of integration between web based content guides and set top box based content guides result can be problematic. For example, a web based content guide does not reflect any knowledge of the service tier provided to a particular customer. The service tier can indicate which channels are available to the customer and whether the customer is authorized for Video-On-Demand (VOD) or Pay-Per-View (PPV) type services. Additionally, the web based content guide does not reflect knowledge of parental control settings for the set top box.

Accordingly, there is a need for an improved system and method of providing a television content guide via a set top box.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram representative of a television system;

FIG. 2 is a flow chart to illustrate a method of providing a content guide to a computer;

FIG. 3 is a flow chart to illustrate a method of providing a content guide to a television via a set top box; and

FIG. 4 is a flow chart to illustrate a method of applying user settings to multiple set top boxes.

### DETAILED DESCRIPTION OF THE DRAWINGS

A method of providing a content guide includes receiving a request for a content guide. The request for the content guide is transmitted to a web server. Thereafter, the content guide is received from the web server. Further, the content guide is modified according to one or more parental controls after determining that the one or more parental controls are enabled.

In a particular embodiment, the method further includes retrieving the one or more parental controls from a database within a set top box server before modifying the content guide. Also, in a particular embodiment, the one or more parental controls can prevent one or more programs from being available at a television coupled to the set top box at least partially based on a rating associated with the one or more program. Further, the content guide is modified to delete information associated with the one or more programs not available at the television.

In a particular embodiment, the method also includes retrieving a service level agreement from the database within the set top box server. The content guide is modified according to the service level agreement. In a particular embodiment, the service level agreement defines one or more channels to be received at the set top box and one or more channels not to be received at the set top box. The content guide is modified to delete information associated with the one or more channels not to be received at the set top box. In a particular embodiment, a modified content guide is transmitted to the set top box. Then, the modified content guide is transmitted to a television.

In another embodiment, a method of providing a content guide includes receiving a request for a content guide from a computer at a web server and modifying a content guide according to one or more parental controls after determining that the one or more parental controls are enabled.

In yet another embodiment, a method of communicating one or more settings to a set top box is provided and includes receiving at least one parental control setting at a set top box server. The at least one parental control setting is transmitted from the set top box server to a plurality of set top boxes at a customer location.

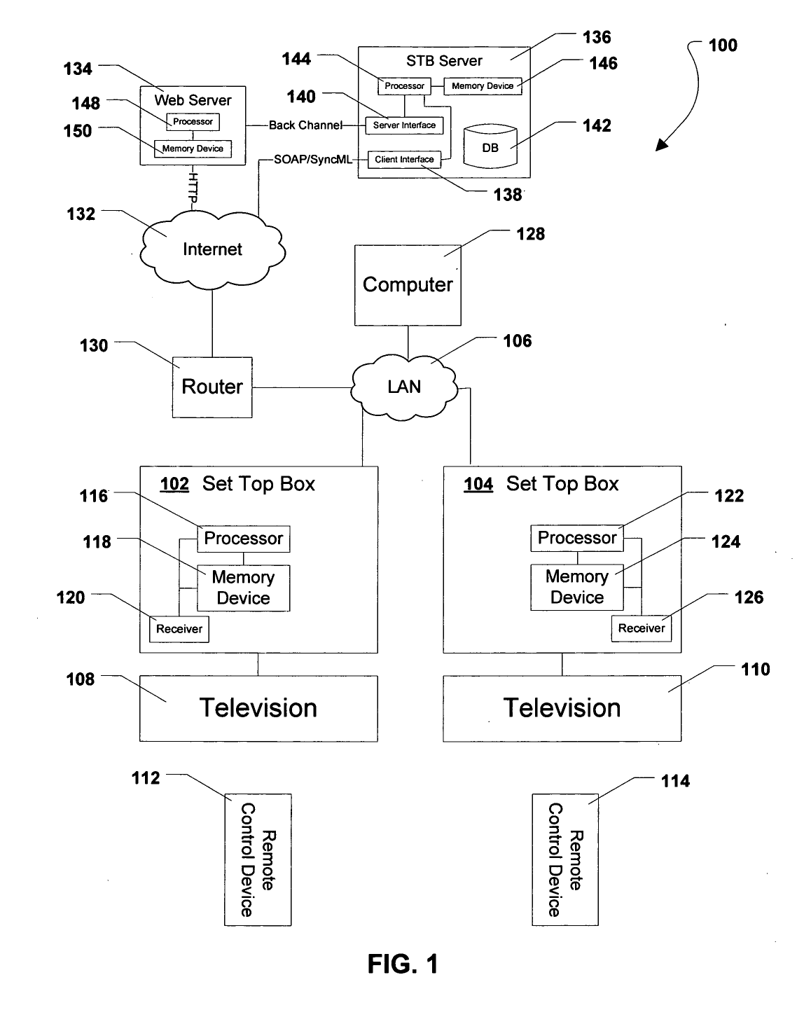

Referring initially to FIG. 1, a video system is shown and is generally designated 100. As shown, the system 100 includes a first set top box 102 and a second set top box 104 that are coupled to a local area network (LAN) 106 at a customer location. As further depicted in FIG. 1, the system 100 includes a first television 108 that is coupled to the first set top box 102. Also, a second television 110 is coupled to the second set top box 104. A first remote control device 112 is provided and can be used to send control signals to the first set top box 102 and the first television 108. Moreover, a second remote control device 114 is provided and can be used to send one or more control signals to the second set top box 104 and the second television 110.

As further illustrated in FIG. 1, the first set top box 102 includes a processor 116. A memory device 118 and a receiver 120 are coupled to the processor 116. In a particular embodiment, the receiver 120 can be a radio frequency (RF) receiver or an infrared receiver (IR) receiver. Further, the receiver 120 can receive one or more control signals from the first remote control device 112. FIG. 1 further shows that the second set top box 104 can include a processor 122 to which a memory device 124 and a receiver 126 are connected. The receiver 126 within the second set top box 104 can receive one or more control signals from the second remote control device 112.

FIG. 1 shows that a computer 128 can be coupled to the LAN 106. In a particular embodiment, the computer 128 can be a lap top computer, a desktop computer, a portable data assistant, or any other computing device. As depicted in FIG. 1, a router 130 is also coupled to the LAN 106. In a particular embodiment, the router 130 can provide connectivity to the Internet 132. In turn, the Internet 132 can connect the set top boxes 102, 104 and the computer 128 to a web server 134 and a set top box (STB) server 136. In an exemplary embodiment, the router 130 servers as a router, a firewall, and a network address translator (NAT) device.

As indicated in FIG. 1, the STB server 136 includes a client interface 138 that is coupled to the Internet 132. In an illustrative embodiment, each set top box 102, 104 can communicate with the STB server 136, e.g., the client interface 138, over the Internet 132 using simple object access protocol (SOAP) or SyncML. As depicted, the STB server 136 can also include a server interface 140 that allows the web server 134 to communicate with the STB server 136 via a back channel. In a particular embodiment, a user can access the web server 134 using the computer 128, or any other computer, using hypertext transfer protocol (HTTP) and can set one or more parental settings for the set top boxes 102, 104 or the user can remotely program one or more of the set top boxes 102, 104.

FIG. 1 also shows that the STB server 136 includes a database 142. In a particular embodiment, the database 142 includes information relevant to customer accounts. For example, the database 142 can include a service level agreement for each customer account and any parental controls for each customer account. Further as shown in FIG. 1, the STB server 136 can include a processor 144 and a memory device 146. A computer program can be embedded within the memory device 148. In a particular embodiment, the processor 144 can execute the computer program in order to modify a content guide received from the web server 132 prior to sending the content guide to the set top boxes 102, 104.

The web server 134 can also include a processor 148 and a memory device 150 coupled to the processor 148. A computer program can be embedded within the memory device 150 and the computer program can be executed by the processor 148 in order to modify a content guide based on one or more parental controls or a service level agreement received from the STB server 136.

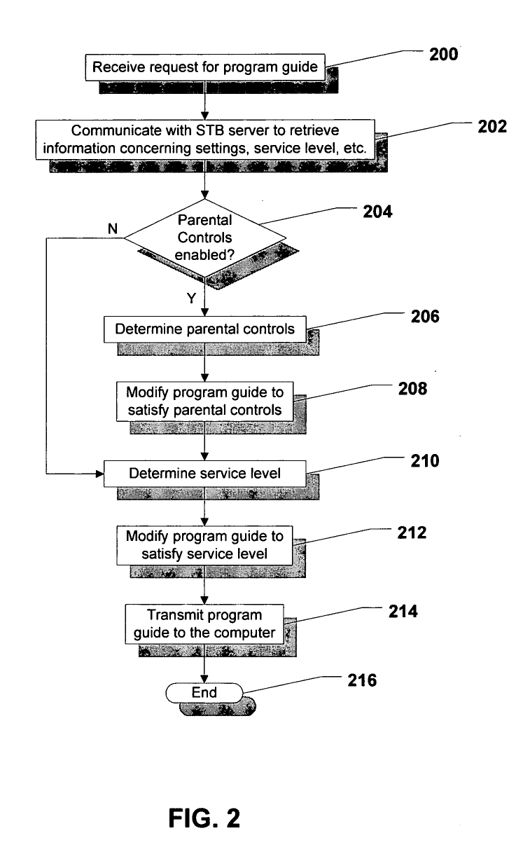

Referring to FIG. 2, a method of providing a content guide to a computer is shown and commences at block 200. At block 200, a web server receives a request for a content guide, e.g., from a user computer. Next, at block 202, the web server communicates with a set top box (STB) server to retrieve information concerning one or more parental controls and the service level agreement governing the customer's television services.

Proceeding to decision step 204, the web server determines whether parental controls are enabled for the particular customer who requested the content guide. If the parental controls are enabled, the web server determines what parental controls are enabled at block 206. For example, the parental controls can limit one or more channels from being received at the set top box. Further, the parental controls can also limit particular programs from being presented at the set top box based on the ratings of the programs. The ratings can include TV-Y, TV-Y7, TV-G, TV-PG, TV-14, TV-MA, D, S, L, V, G, PG, R, NR, etc.

Moving to block 208, the web server modifies the content guide to satisfy the parental controls. From block 208, the method moves to block 210. Returning to decision step 204, if the parental controls are not enabled, the method moves directly to block 210 and the web server does not modify the content guide based on any parental controls. At block 210, the web server determines the service level associated with the customer's account based on the service level agreement between the customer and the content provider. Proceeding to block 212, the web server modifies the content guide to satisfy the service level purchased by the customer. For example, if the customer's service only includes basic service, then the content associated with the channels included in the basic service plan is shown in the content guide. Further, if the customer's service includes premium service, the content associated with the premium channels purchased by the customer are added to the basic content guide.

As such, the content guide can be modified based on any parental controls, if enabled, and further modified based on the customer's service level agreement. Proceeding to block 214, the web server transmits the modified content guide to the user computer. The method then ends at state 216.

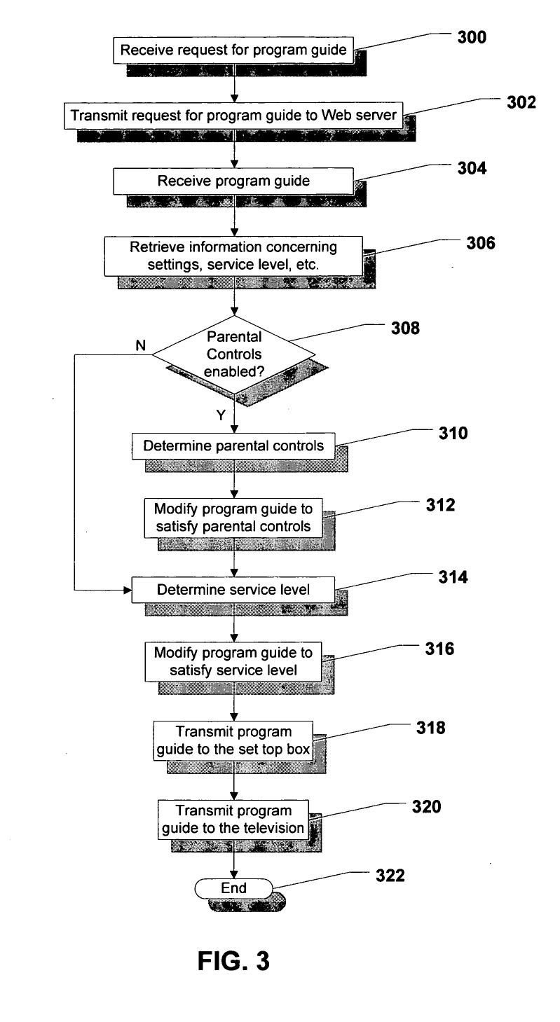

Referring now to FIG. 3, a method of providing a content guide to a television via a set top box is shown and commences at block 300. At block 300, the set top box receives a request for a content guide, e.g., from a remote control device. Next, at block 302, the set top box transmits the request for the content guide to a web server. At block 304, the set top box (STB) server receives the content guide from the web server. Moving to block 306, the STB server retrieves information concerning one or more parental controls and the service level agreement governing the customer's television services.

Proceeding to decision step 308, the STB server determines whether parental controls are enabled for the particular customer who requested the content guide. If the parental controls are enabled, the STB server determines what parental controls are enabled at block 310. Moving to block 312, the STB server modifies the content guide to satisfy the parental controls. From block 312, the method moves to block 314.

Returning to decision step 308, if the parental controls are not enabled, the method moves directly to block 314 and the STB server does not modify the content guide based on any parental controls. At block 314, the STB server determines the service level associated with the customer's account based on the service level agreement between the customer and the content provider. Proceeding to block 316, the STB server modifies the content guide to satisfy the service level purchased by the customer. For example, if the customer's service only includes basic service, only content associated with the channels included in the basic service plan is shown in the content guide. Further, if the customer's service includes premium service, the content associated with the premium channels purchased by the customer are added to the basic content guide.

As such, the content guide can be modified based on any parental controls, if enabled, and further modified based on the customer's service level agreement. Proceeding to block 318, the STB server transmits the modified content guide to the set top box. Then, at block 320, the set top box can transmit the modified content guide to a television. The method then ends at state 322.

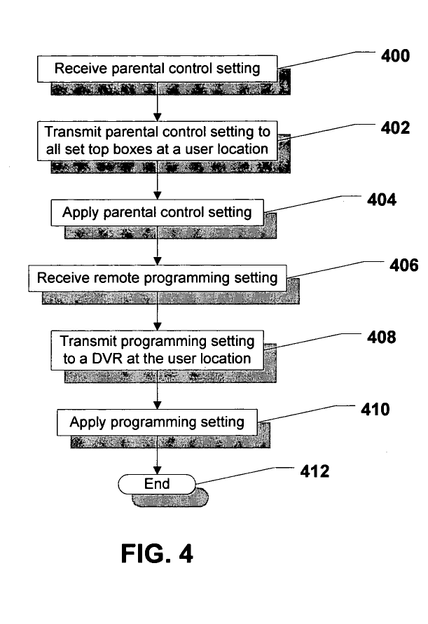

FIG. 4 illustrates a method of applying user settings to multiple set top boxes. Commencing at block 400, one or more parental control settings are received from a set top box or from a computer, e.g., a computer at the user location or a computer at a remote location. Parental control settings received from the set top box can be received at a set top box (STB) server. On the other hand, parental control settings received from the computer can be received at a web server and transmitted to the STB server. Thereafter, at block 402, the STB server transmits the parental control setting to multiple set top boxes at the user location. Moving to block 404, each set top box applies the user selected parental control settings. Accordingly, each set top box includes the same parental control settings and can be consistently applied at the customer location.

Proceeding to block 406, one or more remote programming settings are received, e.g., from a remote computer not at the customer location. In a particular embodiment, the programming setting can be an indication to record a particular program at a particular time. Additionally, the programming setting can include a request to record all episodes of a particular program. In a particular embodiment, the remote programming settings can be received at a web server and transmitted to the STB server. Next, at block 408, the STB server transmits the programming setting to a set top box at the user location that includes a digital video recorder (DVR). At block 410, the set top box applies the programming setting. The method then ends at state 412.

With the configuration of structure described above, the system and method of providing a television content guide provides a way for a user to receive a web based content guide at a set top box. The web based content guide is modified to reflect the user's parental control settings and the user's service level agreement. Accordingly, the content guide presented via the set top box does not include any information concerning content that the user does not want displayed or any information concerning content that the user is not receiving.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing a content guide, the method comprising:
receiving a request for a content guide;
transmitting the request for the content guide to a web server;
receiving the content guide from the web server; and
modifying the content guide according to one or more parental controls after determining that the one or more parental controls are enabled.

2. The method of claim 1, further comprising retrieving the one or more parental controls from a database within a set top box server before modifying the content guide.

3. The method of claim 2, wherein the one or more parental controls prevents one or more programs from being available at a television coupled to the set top box at least partially based on a rating associated with the one or more program.

4. The method of claim 3, wherein the content guide is modified to delete information associated with the one or more programs not available at the television.

5. The method of claim 2, further comprising retrieving a service level agreement from the database within the set top box server.

6. The method of claim 5, further comprising modifying the content guide according to the service level agreement.

7. The method of claim 6, wherein the service level agreement defines one or more channels to be received at the set top box and one or more channels not to be received at the set top box.

8. The method of claim 7, wherein the content guide is modified to delete information associated with the one or more channels not to be received at the set top box.

9. The method of claim 8, further comprising transmitting a modified content guide to the set top box.

10. The method of claim 9, further comprising transmitting the modified content guide to a television.

11. A method of providing a content guide, the method comprising:
receiving a request for a content guide from a computer at a web server; and
modifying a content guide according to one or more parental controls after determining that the one or more parental controls are enabled.

12. The method of claim 11, further comprising retrieving the one or more parental controls from a set top box server before modifying the content guide.

13. The method of claim 12, further comprising retrieving a service level agreement from the set top box server.

14. The method of claim 13, further comprising modifying the content guide according to the service level agreement.

15. The method of claim 14, further comprising communicating the modified content guide to the computer.

16. A method of communicating one or more settings to a set top box, the method comprising:
receiving at least one parental control setting at a set top box server; and
transmitting the at least one parental control setting from the set top box server to a plurality of set top boxes at a customer location.

17. The method of claim 16, wherein the at least one parental control setting is received from a set top box.

18. The method of claim 17, wherein the at least one parental control setting is received from a computer via a web server.

19. The method of claim 18, further comprising receiving a programming setting for a digital video recorder at the set top box server.

20. The method of claim 19, further comprising transmitting the programming setting to a digital video recorder at a customer location.

21. The method of claim 20, wherein the programming setting is received remotely from a computer via the web server.

22. The method of claim 20, further comprising applying the programming setting at the digital video recorder.
